(19) United States
(12) Patent Application Publication
(10) Pub. No.: US 2022/0059079 A1
(43) Pub. Date: Feb. 24, 2022

(54) SERVICE PROVIDING SYSTEM AND METHOD USING VOICE RECOGNITION ACCESSORY

(71) Applicant: O2O CO., LTD., Chuncheon-si, Gangwon-do (KR)

(72) Inventors: Sung Min AHN, Seongnam-si, Gyeonggi-do (KR); Dong Gil PARK, Seongnam-si, Gyeonggi-do (KR); Ki Min YUN, Seoul (KR)

(73) Assignee: O2O CO., LTD., Chuncheon-si, Gangwon-do (KR)

(21) Appl. No.: 17/418,841

(22) PCT Filed: Oct. 14, 2019
(86) PCT No.: PCT/KR2019/013433

§ 371 Date: Jun. 27, 2021

(30) Foreign Application Priority Data
Jun. 11, 2019 (KR) 10-2019-0068525

(51) Int. Cl. G10L 15/08; H04W 4/80

(52) U.S. Cl. CPC G10L 15/08; G10L 2015/088; H04W 4/80

(57) ABSTRACT

A service providing system includes: a voice recognition accessory which recognizes a user's voice, generates a wake-up signal corresponding to the recognized voice, and transmits the wake-up signal in real time; a mobile terminal which receives the wake-up signal from the voice recognition accessory in real time so as to recognize the wake-up signal, and runs an application according to the recognized wake-up signal; and a service providing server for communicating with the application running in the mobile terminal so as to provide a corresponding service.

### TECHNICAL FIELD

The present invention relates to a system and method for providing a predetermined service, and more particularly, to a service providing system and method using a voice recognition accessory.

### BACKGROUND ART

Apple's iPhone and Samsung's Galaxy phone provide AI assistant services using a call word such as Siri or Bixby.

When a user pronounces the call word Siri or Bixby, an AI assistant service application of Apple or Galaxy runs automatically.

Here, since a mobile phone should continuously receive the surrounding voice and recognize the call word, the accuracy of recognition is very important.

However, when the user is at a distance from the mobile phone, there is a problem that the recognition rate of the call word is lowered because the call word is pronounced at a distance from the mobile phone.

In addition, there is a problem that the recognition rate for specific voice commands is also lowered at a distance.

Accordingly, there is a need for a means capable of providing a smooth AI assistant service even when the user's movement and activity area are further expanded.

### RELATED ART LITERATURE

[Patent Literature]

(Patent Document 1) Korean Patent No. 10-2014-0102339

(Patent Document 2) Korean Laid-open Patent Application No. 10-1560448

### DISCLOSURE

### Technical Problem

An object of the present invention is to provide a service providing system using a voice recognition accessory.

Another object of the present invention is to provide a service providing method using a voice recognition accessory.

### Technical Solution

A service providing system using a voice recognition accessory according to the object of the present invention described above includes: a voice recognition accessory that recognizes a user's call word, generates a wake-up signal corresponding to the recognized call word, and transmits the wake-up signal in real time; a mobile terminal that receives the wake-up signal from the voice recognition accessory in real time to recognize the wake-up signal and drives an application according to the recognized wake-up signal; and a service providing server that communicates with the application driven by the mobile terminal to provide a corresponding service.

Here, the application and the service providing server may be separately provided for each of the corresponding service.

In addition, the voice recognition accessory may transmit the wake-up signal to the mobile terminal using Bluetooth communication.

A service providing method using a voice recognition accessory according to another object of the present invention described above includes: a step in which the voice recognition accessory recognizes a user's call word; a step in which the voice recognition accessory generates a wake-up signal corresponding to the recognized call word; a step in which the voice recognition accessory transmits the generated wake-up signal to a mobile terminal in real time and the mobile terminal receives the wake-up signal from the voice recognition accessory in real time; a step in which the mobile terminal recognizes the wake-up signal received in real time and operates an application according to the recognized wake-up signal; and a step in which a service providing server provides a service by the application operated in the mobile terminal to the mobile terminal.

Here, the application and the service providing server may be separately provided for each of the corresponding service.

In addition, the step in which the voice recognition accessory transmits the generated wake-up signal to the mobile terminal in real time and the mobile terminal receives the wake-up signal from the voice recognition accessory in real time may transmit and receive the wake-up signal using Bluetooth communication.

### Advantageous Effects

According to the service providing system and method using the above-described voice recognition accessory, it is configured to receive a call word from a distance away from a mobile phone using the voice recognition accessory that can be easily carried by a user, and thus, there is an effect that can increase a recognition rate of the call word and smoothly provide AI services of the mobile phone.

In particular, since a recognition rate of voice commands can be increased, there is an effect that an AI assistant service application can be used smoothly even from a distance.

In addition, it is configured to directly input and set call words for various applications, and thus, there is an effect that users can easily use applications that are frequently used.

### DESCRIPTION OF DRAWINGS

FIG. 1 is a block diagram of a service providing system using a voice recognition accessory according to an embodiment of the present invention.

FIG. 2 is a flowchart of a service providing method using a voice recognition accessory according to an embodiment of the present invention.

### DESCRIPTION OF REFERENCE NUMERALS

110: Voice recognition accessory

111: Microphone

112: AEC processing module

113: Voice recognition module

114: Call word detection module

115: Call word database

116: Bluetooth communication module

117: Call word input/save module

120: Mobile terminal

121: Bluetooth communication module

122: Call word recognition module

123: Call word-application database

124: Application execution module

125: Voice command delivery module

126: Mobile communication module

127: Microphone

128: Voice recognition module

129: Call word input/save control module

130: Service providing serve

### MODES OF THE INVENTION

The present invention may be subjected to various modifications and may have several embodiments, and thus specific embodiments thereof will be illustrated in the drawings and described in specific contents for carrying out the invention in detail. However, there is no intent to limit the present invention to specific embodiments, and it should be understood to include all modifications, equivalents, or alternatives that fall in the spirit and scope of the present invention. In describing each drawing, similar reference numerals are used for similar components.

The terms such as first, second, A, and B may be used to describe various elements, but the elements should not be limited by the terms. The terms are used only for distinguishing one element from other components. For example, the first element may be referred to as the second element without departing from the scope of the present invention, and similarly, the second element may be referred to as the first element. The terms and/or include a combination of a plurality of related entries or one of a plurality of related entries.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terms used in this application are only used to describe specific embodiments, and are not intended to limit the present invention. A singular expression includes a plural expression unless the context clearly refers to otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless defined otherwise, all terms used herein, including technical or scientific terms, have the same meaning as commonly understood by a person skilled in the art to which the present invention pertains. Terms such as those defined in a commonly used dictionaries should be interpreted as having a meaning that is consistent with their meaning in the context of the relevant art and are not interpreted as ideal or excessively formal meanings unless expressly defined in this application.

Hereinafter, preferred embodiments of the present invention will be described in detail with reference to the accompanying drawings.

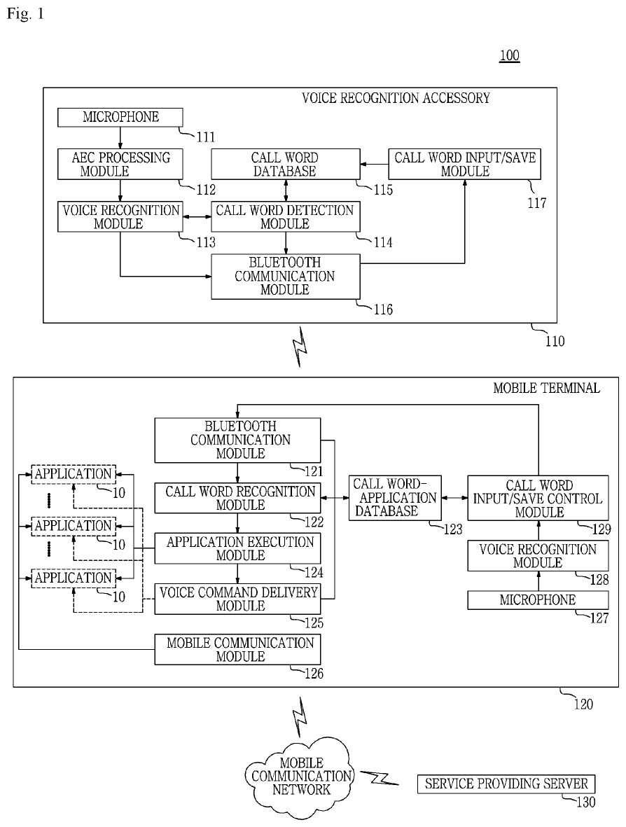

FIG. 1 is a block diagram of a service providing system using a voice recognition accessory according to an embodiment of the present invention.

Referring to FIG. 1, a service providing system 100 using the voice recognition accessory according to an embodiment of the present invention may include a voice recognition accessory 110, a mobile terminal 120, and a service providing server 130.

The service providing system 100 using the voice recognition accessory may input a voice using the voice recognition accessory 110 capable of Bluetooth communication with the mobile terminal 120 to invoke a specific application 10.

In addition to a call word, other voice commands may be input using the voice recognition accessory 110 to increase a voice recognition rate, and users may conveniently enjoy AI services while moving within a predetermined space.

Hereinafter, a detailed configuration will be described.

The voice recognition accessory 110 may receive a user's voice to recognize it.

The voice recognition accessory 110 may be connected to the mobile terminal 120 via Bluetooth, and may be conveniently carried by a user or attached to the user's body.

For example, the voice recognition accessory 110 may be manufactured in a shape such as a necklace type or a band type.

The voice recognition accessory 110 may recognize the user's call word, and may generate a wake-up signal corresponding to the call word and transmit the wake-up signal to the mobile terminal 120 in real time. Here, the voice recognition accessory 110 may be connected to the mobile terminal 120 via Bluetooth, and the wake-up signal may be transmitted through Bluetooth communication.

The voice recognition accessory 110 may include a microphone 111, an acoustic echo cancellation (AEC) processing module 112, a voice recognition module 113, a call word detection module 114, a call word database 115, a Bluetooth communication module 116, and a call word input/save module 117. Hereinafter, a detailed configuration will be described.

The microphone 111 may receive a user's voice. The user's voice may include a call word or voice command.

The AEC processing module 112 may remove noise and echo from the voice input from the microphone 111 to output the voice.

The voice recognition module 113 may recognize the voice output from the AEC processing module 112. Here, the voice recognition module 113 may analyze a voice frequency to distinguish whether the voice is the user's voice or not. A next operation is possible only when the voice recognition module 113 recognizes that the voice is the user's voice.

The call word detection module 114 may detect the call word in the voice recognized by the voice recognition module 113 using a keyword spotting algorithm. The call word detection module 114 may detect the call word when the voice recognition module 113 recognizes that the voice is the user's voice.

Here, the call word detection module 114 may refer to a call word saved in advance in the call word database 115 to detect the call word.

In the call word database 115, a call word for waking up an AI assistant service application or other application 10 may be mapped and saved in advance.

The Bluetooth communication module 116 may perform Bluetooth communication with the mobile terminal 120.

The Bluetooth communication module 116 may transmit the call word detected by the call word detection module 114 to the mobile terminal 120 in real time.

Meanwhile, the voice recognition module 113 may enter a voice command standby mode after the call word is detected from the call word detection module 114. The voice recognized in the voice command standby mode may be recognized as a voice command.

The Bluetooth communication module 116 may transmit the voice command recognized by the voice recognition module 113 to the mobile terminal 120.

Meanwhile, the Bluetooth communication module 116 may receive a call word newly input and set by the user from the mobile terminal 120.

The call word input/save module 117 may input the call word received by the Bluetooth communication module 116 into the call word database 115 and update and save the call word.

The mobile terminal 120 may receive and recognize a wake-up signal in real time from the voice recognition accessory 110 and execute the application 10 corresponding to the wake-up signal.

The voice recognition accessory 110 or the mobile terminal 120 described above may be separately provided for each AI service or application 10.

The mobile terminal 120 may include a Bluetooth communication module 121, a call word recognition module 122, a call word-application database 123, an application execution module 124, a voice command delivery module 125, a mobile communication module 126, a microphone 127, a voice recognition module 128, and a call word input/save control module 129. Hereinafter, a detailed configuration will be described.

The Bluetooth communication module 121 may perform Bluetooth communication with the voice recognition accessory 110.

The Bluetooth communication module 121 may receive a call word from the voice recognition accessory 110.

The call word recognition module 122 may recognize the call word received by the Bluetooth communication module 121. The call word recognition module 122 may refer to a corresponding pair of call word-application saved in advance in the call word-application database 123 to recognize which application 10 is to be invoked by the call word.

The call word-application database 123 may save a corresponding pair of call word-application in advance. For example, the AI assistant service application of Apple's iPhone may be saved in correspondence with the call word “Siri”. The AI assistant service application of Samsung's Galaxy phone may be saved in correspondence with the call word “Bixby”.

The application execution module 124 may wake-up the application 10 corresponding to a call word recognized by the call word recognition module 122 to execute the application 10.

While a specific application 10 is executed by the application execution module 124, the voice command delivery module 125 may input to transmit a user's voice command for performing a function of the application 10 to the application 10.

Here, the user's voice command may be received from the voice recognition accessory 110 through the Bluetooth communication module 121.

The application 10 may need to receive necessary services from the service providing server 130 of the application 10. In this case, the application 10 may communicate with the service providing server 130.

The application 10 may transmit the user's voice command to the service providing server 130 through the mobile communication module 126. For example, when the voice command is a specific search command, the search command may be transmitted to the service providing server 130.

The microphone 127 is a configuration for receiving the user's voice. Here, the microphone 127 may be used when the user wants to directly designate a call word for waking up the specific application 10.

The voice recognition module 128 may recognize the voice input from the microphone 127. Here, the voice may be a call word.

The call word input/save control module 129 may input the call word recognized by the voice recognition module 128 into the call word-application database 123 to update and save the call word.

The user may directly input and set a call word for each application 10 installed in the mobile terminal 120, and may change and save an existing call word such as “Siri” or “Bixby”. A specific call word that only the user should know may be newly saved, or may be changed and saved.

Meanwhile, an application lock setting module (not shown) may set to lock the specific application 10 according to a user's input. The lock set application 10 may wake up and be executed only when the user invokes it. That is, the lock set application 10 is not unlocked by pattern input, password input, or fingerprint input, but the corresponding application 10 is unlocked and executed only by a user's voice fingerprint and the call word directly designated by the user.

In this case, the corresponding application 10 may be securely protected by a double security setting of the user's call word as well as the user's voice fingerprint.

The call word input/save control module 129 may transmit the call word of the corresponding pair of call word-application saved in the call word-application database 123 to the voice recognition accessory 110 through the Bluetooth communication module 121. The voice recognition accessory 110 may receive a call word from the mobile terminal 120 to update and save the call word in the call word database 115.

The service providing server 130 may communicate with the specific application 10 of the mobile terminal 120 and provide a service required by the application 10.

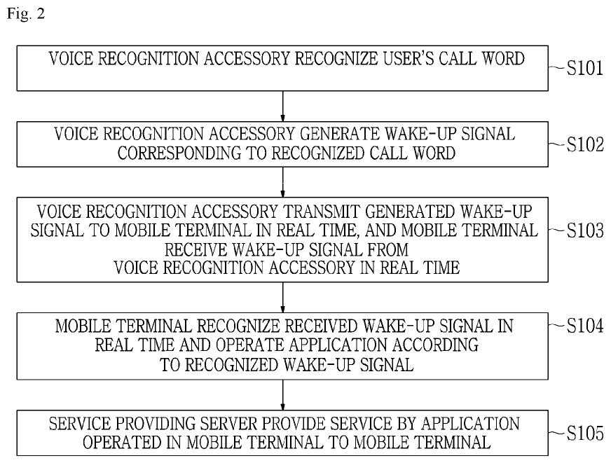

FIG. 2 is a flowchart of a service providing method using a voice recognition accessory according to an embodiment of the present invention.

Referring to FIG. 2, the voice recognition accessory 110 recognizes a user's call word (S101).

Next, the voice recognition accessory 110 generates a wake-up signal corresponding to the recognized call word (S102).

Next, the voice recognition accessory 110 transmits the generated wake-up signal to the mobile terminal 120 in real time, and the mobile terminal 120 receives the wake-up signal from the voice recognition accessory 110 in real time (S103).

At this time, the voice recognition accessory 110 and the mobile terminal 120 may transmit and receive the wake-up signal using Bluetooth communication.

Next, the mobile terminal 120 recognizes the wake-up signal received in real time and operates the application 10 according to the recognized wake-up signal (S104).

Next, the service providing server 130 provides a service by the application 10 operated in the mobile terminal 120 to the mobile terminal 120 (S105).

Here, the application 10 and the service providing server 130 may be separately provided for each of the corresponding service.

Although the present invention has been described with reference to the embodiments, those skilled in the art may understand that the present invention may be variously modified and changed within a scope not departing from the spirit and scope of the present invention described in the following claims.

1. A service providing system using a voice recognition accessory, comprising:
a voice recognition accessory that recognizes a user's call word, generates a wake-up signal corresponding to the recognized call word, and transmits the wake-up signal in real time;
a mobile terminal that receives the wake-up signal from the voice recognition accessory in real time to recognize the wake-up signal and drives an application according to the recognized wake-up signal; and
a service providing server that communicates with the application driven by the mobile terminal to provide a corresponding service.

2. The service providing system using the voice recognition accessory of claim 1, wherein the application and the service providing server are provided separately for each of the corresponding service.

3. The service providing system using the voice recognition accessory of claim 1, wherein the voice recognition accessory transmits the wake-up signal to the mobile terminal using Bluetooth communication.

4. A service providing method using a voice recognition accessory, comprising:
a step in which the voice recognition accessory recognizes a user's call word;
a step in which the voice recognition accessory generates a wake-up signal corresponding to the recognized call word;
a step in which the voice recognition accessory transmits the generated wake-up signal to a mobile terminal in real time and the mobile terminal receives the wake-up signal from the voice recognition accessory in real time;
a step in which the mobile terminal recognizes the wake-up signal received in real time and operates an application according to the recognized wake-up signal; and
a step in which a service providing server provides a service by the application operated in the mobile terminal to the mobile terminal.

5. The service providing method using the voice recognition accessory of claim 4, wherein the application and the service providing server are provided separately for each of the corresponding service.

6. The service providing method using the voice recognition accessory of claim 4, wherein the step in which the voice recognition accessory transmits the generated wake-up signal to the mobile terminal in real time and the mobile terminal receives the wake-up signal from the voice recognition accessory in real time transmits and receives the wake-up signal using Bluetooth communication.
